(19) United States
(12) Patent Application Publication
(10) Pub. No.: US 2025/0306238 A1
(43) Pub. Date: Oct. 2, 2025

(54) METHOD FOR DELINEATING ECOLOGICAL CORRIDOR BASED ON MAXIMUM SIMILARITY MODEL AND DEVICE THEREOF

(71) Applicant: Satellite Application Center for Ecology and Environment, MEE, Beijing (CN)

(72) Inventors: Jixi GAO, Beijing (CN); Huawei WAN, Beijing (CN); Mengdi WEN, Beijing (CN); Peirong SHI, Beijing (CN); Peng HOU, Beijing (CN); Yongcai WANG, Beijing (CN); Zhiru ZHANG, Beijing (CN); Chenxi SUN, Beijing (CN)

(73) Assignee: Satellite Application Center for Ecology and Environment, MEE, Beijing (CN)

(21) Appl. No.: 19/093,306

(22) Filed: Mar. 28, 2025

(30) Foreign Application Priority Data
Mar. 28, 2024 (CN) 202410363602.7

(51) Int. Cl. G01V 20/00

(52) U.S. Cl. CPC G01V 20/00

(57) ABSTRACT

A method for delineating an ecological corridor based on a maximum similarity model determines ecosystem type according to the determined ecological source, and assigns a habitat suitability index; and according to a maximum similarity matrix between different ecosystems, assigns the habitat suitability index to peripheral pixels of the selected ecological source, to obtain a similar value of the habitat suitability index. The habitat suitability index is corrected according to the surface curvature data and population density data, and resistance surface data is calculated according to the corrected value. Based on the resistance surface data, an ecological corridor is delineated comprehensively to find one or more paths corresponding to a minimum cost distance as ecological corridors. The influence of ecological environment on ecological corridor establishment is considered more comprehensively, so that the ecological corridor is delineated more accurately, and applied into practice to maximum extent.

### TECHNICAL FIELD

The present disclosure relates to the field of ecological monitoring, and in particular to a method for delineating an ecological corridor based on a maximum similarity model and a device thereof.

### BACKGROUND TECHNOLOGY

With the rapid development of cities and towns, it is difficult to avoid the over-exploitation of land and the massive encroachment of ecological environment patches, which results in many problems such as the decrease of biodiversity, the fragmentation of habitat patches and the instability of the ecological environment. In order to solve the problems such as biodiversity protection, it is necessary to strengthen the connection between nature reserves, and build potential ecological corridors by connecting nature reserves, so as to form an ecological network. Maintaining the connection between isolated habitat patches and constructing ecological corridors have become an important way to eliminate habitat fragmentation. In order to protect biodiversity, maintain ecological balance and reduce habitat fragmentation, it is crucial to plan and build ecological corridors better. At the same time, this also provides more basis for relevant departments to evaluate the ecological quality.

At present, for the delineation of ecological corridors, in addition to a superposition method of a single-factor ecological security pattern based on ecological constraint diagnosis, the application of a minimum cumulative resistance model to simulate corridor trend orientation has become the mainstream paradigm in the ecological corridor research. The minimum cumulative resistance model can better express the interaction relationship between a landscape pattern and an ecological process. The core parameters of the minimum cumulative resistance model includes selecting ecological sources, constructing a resistance surface and extracting a minimum cost path between ecological sources.

The key of the minimum cumulative resistance model is the construction of the resistance surface. The resistance surface is mainly determined based on land-use/cover pattern parameters, corrected land-use pattern parameters (such as a corrected water area, a corrected construction land, etc.) or an ecosystem service price in comprehensive consideration of the characteristics such as spatial difference characteristics of an ecosystem service function, landscape location characteristics and ecological footprints. In the actual analysis, it is necessary to comprehensively consider the land-use pattern, the slope pattern, the influence of human activities and so on. However, the land-use pattern is limited by the classification precision, and the uniform assignment would cover up the difference in the influence of human disturbance on the ecological resistance coefficient under the same land-use pattern, so that it is necessary to superimpose human activity data. At the same time, when the minimum cumulative resistance model is used to calculate a final distance to generate an ecological corridor, a pixel is abstracted as a point, and some properties of the pixel are not taken into account. The final ecological corridor is only the most unobstructed channel after simply taking into account the resistance, which may not be directly applied to the local environment in practice.

### CONTENT OF THE INVENTION

In order to solve the above technical problems, the present disclosure provides a method for delineating an ecological corridor based on a maximum similarity model and a device thereof, which can delineate the ecological corridor more accurately and provide a technical support for relevant departments to carry out ecological planning and biodiversity protection.

The present disclosure provides the following technical schemes.

A method for delineating an ecological corridor based on a maximum similarity model is provided, wherein the method includes:
S1: acquiring ecological source vector data, land-use classification data, surface curvature data and population density data of an area to be researched;
S2: establishing a habitat suitability maximum similarity matrix of the area to be researched according to the land-use classification data;
S3: assigning an initial habitat suitability index to each of all pixels according to a land-use pattern of an ecological source and the habitat suitability maximum similarity matrix, to calculate basic resistance surface data of the area to be researched;
S4: correcting the initial habitat suitability index of each pixel according to the surface curvature data and the population density data, to obtain an ecological corridor suitability evaluation index of each pixel, and calculating final resistance surface data of the area to be researched according to the ecological corridor suitability evaluation index;
S5: for any two selected ecological sources, calculating a minimum cost distance of all paths from one ecological source to an other ecological source according to the final resistance surface data, and taking a path corresponding to the minimum cost distance as an ecological corridor between the two selected ecological sources.

Further, the land-use pattern included in the land-use classification data includes a forest land, a shrub land, a high coverage grassland, a low coverage grassland, a cultivated land, a water body, an unused land and a construction land.

Further, S2 includes:
establishing the following habitat suitability maximum similarity matrix of the area to be researched according to the land-use classification data;

| | | | High | Low | | | | |
|---|---|---|---|---|---|---|---|---|
| | Forest | Shrub | coverage | coverage | Cultivated | Water | Unused | Construction |
| | land | land | grassland | grassland | land | body | land | land |
| Forest | 1.0 | 0.9 | 0.7 | 0.6 | 0.4 | 0.3 | 0.1 | 0.0 |
| land | | | | | | | | |
| Shrub | 0.9 | 1.0 | 0.7 | 0.6 | 0.4 | 0.3 | 0.1 | 0.0 |
| land | | | | | | | | |
| High | 0.6 | 0.7 | 1.0 | 0.9 | 0.4 | 0.3 | 0.1 | 0.0 |
| coverage | | | | | | | | |
| grassland | | | | | | | | |
| Low | 0.6 | 0.7 | 0.9 | 1.0 | 0.4 | 0.3 | 0.1 | 0.0 |
| coverage | | | | | | | | |
| grassland | | | | | | | | |
| Cultivated | 0.4 | 0.6 | 0.7 | 0.9 | 1.0 | 0.3 | 0.1 | 0.0 |
| land | | | | | | | | |
| Water | 0.7 | 0.6 | 0.4 | 0.3 | 0.9 | 1.0 | 0.1 | 0.0 |
| body | | | | | | | | |

Further, S4 includes:
S41: calculating a correction coefficient of each pixel according to the surface curvature data and the population density data;

$${MC}_{i} = 1 - {IC}_{i} ,$$

$${IC}_{i} = \frac{{IS}_{i} - {IS}_{min}}{{IS}_{max} - {IS}_{min}} ,$$

$${IS}_{i} = \frac{{SC}_{i} - {SC}_{min}}{{SC}_{max} - {SC}_{min}} + \frac{{PD}_{i} - {PD}_{min}}{{PD}_{max} - {PD}_{min}} ,$$

where MCᵢ denotes a correction coefficient of an i-th pixel, where i=1, 2, . . . , N, N denotes the total number of pixels, ICᵢ denotes an interference coefficient of the i-th pixel, ISᵢ denotes an interference score of the i-th pixel, ISₘₐₓ and ISₘᵢₙ denote a maximum value and a minimum value of ISᵢ, respectively, SCᵢ denotes a surface curvature of the i-th pixel, SCₘₐₓ and SCₘᵢₙ denote a maximum value and a minimum value of SCᵢ, respectively, PDᵢ denotes a population density of the i-th pixel, and PDₘₐₓ and PDₘᵢₙ denote a maximum value and a minimum value of PDᵢ, respectively;
S42: correcting the habitat suitability index of each pixel according to the correction coefficient, to obtain the ecological corridor suitability evaluation index of each pixel;

$${CS}_{i} = {HS}_{i} * {MC}_{i} ,$$

where HSᵢ denotes the habitat suitability index of the i-th pixel, and CSᵢ denotes the ecological corridor suitability evaluation index of the i-th pixel;
S43: calculating the final resistance surface data of each pixel according to the ecological corridor suitability evaluation index;

$${R}_{i} = 1 - {CS}_{i} ,$$

where Rᵢ denotes the final resistance surface data of the i-th pixel.

Further, S5 includes:
S51: for the two selected ecological sources, constructing all paths from the one ecological source to the other ecological source;
S52: calculating a cost distance of each path, finding the minimum cost distance, and taking the path corresponding to the minimum cost distance as the ecological corridor between the two selected ecological sources;

$${lcd}_{a , b} = min ( {cd}_{k} ) ,$$

$${cd}_{k} = {\sum }_{j = 1}^{{N}_{k} - 1} {e}_{j , j + 1} ,$$

$${e}_{j , j + 1} = ( \frac{{c}_{j}}{2} + \frac{{c}_{j + 1}}{2} ) {d}_{j , j + 1} ,$$

where lcd_{a,b} denotes the minimum cost distance between the two selected ecological sources a and b, cdₖ denotes the cost distance of a k-th path between the two selected ecological sources a and b, where k=1, 2, . . . , M, M denotes the total number of paths between the two selected ecological sources a and b; e_{j,j+1} denotes a cumulative cost of the j-th and (j+1)-th land-use pattern patches that the k-th path passes through, where j=1, 2, . . . , Nₖ−1, Nₖ denotes the total number of the land-use pattern patches that the k-th path passes through, cⱼ and cⱼ₊₁ denote average values of the resistance surface data of all pixels of the j-th and (j+1)-th land-use pattern patches, respectively, and d_{j,j+1} denotes a center distance between the j-th and (j+1)-th land-use pattern patches.

A device for delineating an ecological corridor based on a maximum similarity model is provided, wherein the device includes:
a data preparation module, configured to acquire ecological source vector data, land-use classification data, surface curvature data and population density data of an area to be researched;
a maximum similarity matrix determination module, configured to establish a habitat suitability maximum similarity matrix of the area to be researched according to the land-use classification data;
a basic resistance surface data determination module, configured to assign an initial habitat suitability index to each of all pixels according to a land-use pattern of an ecological source and the habitat suitability maximum similarity matrix, and calculate basic resistance surface data of the area to be researched;
a final resistance surface data determination module, configured to correct the initial habitat suitability index of each pixel according to the surface curvature data and the population density data, to obtain an ecological corridor suitability evaluation index of each pixel, and calculate final resistance surface data of the area to be researched according to the ecological corridor suitability evaluation index;
an ecological corridor delineation module, configured to, for any two selected ecological sources, calculate a minimum cost distance of all paths from one ecological source to an other ecological source according to the final resistance surface data, and take a path corresponding to the minimum cost distance as an ecological corridor between the two selected ecological sources.

Further, the land-use pattern included in the land-use classification data includes a forest land, a shrub land, a high coverage grassland, a low coverage grassland, a cultivated land, a water body, an unused land and a construction land.

Further, the maximum similarity matrix determination module is configured to: establish the following habitat suitability maximum similarity matrix of the area to be researched according to the land-use classification data;

| | | | High | Low | | | | |
|---|---|---|---|---|---|---|---|---|
| | Forest | Shrub | coverage | coverage | Cultivated | Water | Unused | Construction |
| | land | land | grassland | grassland | land | body | land | land |
| Forest | 1.0 | 0.9 | 0.7 | 0.6 | 0.4 | 0.3 | 0.1 | 0.0 |
| land | | | | | | | | |
| Shrub | 0.9 | 1.0 | 0.7 | 0.6 | 0.4 | 0.3 | 0.1 | 0.0 |
| land | | | | | | | | |
| High | 0.6 | 0.7 | 1.0 | 0.9 | 0.4 | 0.3 | 0.1 | 0.0 |
| coverage | | | | | | | | |
| grassland | | | | | | | | |
| Low | 0.6 | 0.7 | 0.9 | 1.0 | 0.4 | 0.3 | 0.1 | 0.0 |
| coverage | | | | | | | | |
| grassland | | | | | | | | |
| Cultivated | 0.4 | 0.6 | 0.7 | 0.9 | 1.0 | 0.3 | 0.1 | 0.0 |
| land | | | | | | | | |
| Water | 0.7 | 0.6 | 0.4 | 0.3 | 0.9 | 1.0 | 0.1 | 0.0 |
| body | | | | | | | | |

Further, the final resistance surface data determination module includes:
a correction coefficient calculation unit, configured to calculate a correction coefficient of each pixel according to the surface curvature data and the population density data;

$${MC}_{i} = 1 - {IC}_{i} ,$$

$${IC}_{i} = \frac{{IS}_{i} - {IS}_{min}}{{IS}_{max} - {IS}_{min}} ,$$

$${IS}_{i} = \frac{{SC}_{i} - {SC}_{min}}{{SC}_{max} - {SC}_{min}} + \frac{{PD}_{i} - {PD}_{min}}{{PD}_{max} - {PD}_{min}} ,$$

where MCᵢ denotes a correction coefficient of an i-th pixel, where i=1, 2, . . . , N, N denotes the total number of pixels, ICᵢ denotes an interference coefficient of the i-th pixel, ISᵢ denotes an interference score of the i-th pixel, ISₘₐₓ and ISₘᵢₙ denote a maximum value and a minimum value of ISᵢ, respectively, SCᵢ denotes a surface curvature of the i-th pixel, SCₘₐₓ and SCₘᵢₙ denote a maximum value and a minimum value of SCᵢ, respectively, PDᵢ denotes a population density of the i-th pixel, and PDₘₐₓ and PDₘᵢₙ denote a maximum value and a minimum value of PDᵢ, respectively;
an evaluation index calculation unit, configured to correct the habitat suitability index of each pixel according to the correction coefficient, to obtain the ecological corridor suitability evaluation index of each pixel;

$${CS}_{i} = {HS}_{i} * {MC}_{i} ,$$

where HSᵢ denotes the habitat suitability index of the i-th pixel, and CSᵢ denotes the ecological corridor suitability evaluation index of the i-th pixel;
a resistance surface calculation unit, configured to calculate the final resistance surface data of each pixel according to the ecological corridor suitability evaluation index;

$${R}_{i} = 1 - {CS}_{i} ,$$

where Rᵢ denotes the final resistance surface data of the i-th pixel.

Further, the ecological corridor delineation module includes:
a path determination unit, configured to, for the two selected ecological sources, construct all paths from the one ecological source to the other ecological source;
an ecological corridor delineation unit, configured to calculate a cost distance of each path, find a minimum cost distance, and take the path corresponding to the minimum cost distance as the ecological corridor between the two selected ecological sources;

$${lcd}_{a , b} = min ( {cd}_{k} ) ,$$

$${cd}_{k} = {\sum }_{j = 1}^{{N}_{k} - 1} {e}_{j , j + 1} ,$$

$${e}_{j , j + 1} = ( \frac{{c}_{j}}{2} + \frac{{c}_{j + 1}}{2} ) {d}_{j , j + 1} ,$$

where lcd_{a,b} denotes the minimum cost distance between the two selected ecological sources a and b, cdₖ denotes the cost distance of a k-th path between the two selected ecological sources a and b, where k=1, 2, . . . , M, M denotes the total number of paths between the two selected ecological sources a and b; e_{j,j+1} denotes a cumulative cost of the j-th and (j+1)-th land-use pattern patches that the k-th path passes through, where j=1, 2, . . . , Nₖ−1, Nₖ denotes the total number of the land-use pattern patches that the k-th path passes through, cⱼ and cⱼ₊₁ denote average values of the resistance surface data of all pixels of the j-th and (j+1)-th land-use pattern patches, respectively, and d_{j,j+1} denotes a center distance between the j-th and (j+1)-th land-use pattern patches.

The present disclosure has the following beneficial effects.

The present disclosure firstly determines the ecosystem type according to the determined ecological source, and assigns a habitat suitability index; and according to a maximum similarity matrix between different ecosystems, assigns the habitat suitability index to peripheral pixels of the selected ecological source, so as to obtain a similar value of the habitat suitability index. Then, the habitat suitability index is corrected according to the surface curvature data and population density data, and resistance surface data is calculated according to the corrected value. Finally, based on the resistance surface data, an ecological corridor is delineated comprehensively, so as to find one or more paths corresponding to a minimum cost distance as ecological corridors.

According to the present disclosure, the influence of the ecological environment on the establishment of the ecological corridor is taken into account more comprehensively, so that the ecological corridor can be applied into practice to the maximum extent. The establishment of the maximum similarity model is combined with the attributes of the pixels of the ecological source. For different ecosystems such as a forest land, a grassland and a wetland, the similarities vary with their different characteristics. The peripheral pixels of the ecological source are assigned according to the maximum similarity matrix, so that the differences between these ecosystems can be taken into account at the same time during the actual corridor delineation, thereby delineating the ecological corridor more accurately and providing a technical support for relevant departments to carry out ecological planning and biodiversity protection.

### DESCRIPTION OF THE DRAWINGS

FIG. 1 is a flowchart of a method for delineating an ecological corridor based on a maximum similarity model according to the present disclosure.

FIG. 2 is a schematic diagram of a device for delineating an ecological corridor based on a maximum similarity model according to the present disclosure.

### SPECIFIC IMPLEMENTATIONS

In order to make the technical problems, technical schemes and advantages to be solved by the present disclosure more clear, detailed description would be made with reference to the accompanying drawings and specific embodiments hereinafter.

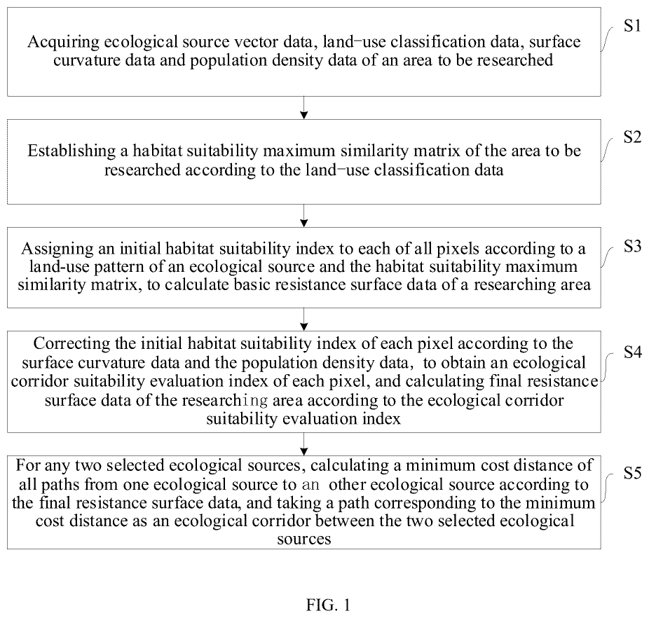

In an embodiment of the present disclosure, a method for delineating an ecological corridor based on a maximum similarity model is provided, as shown in FIG. 1. The method includes the following steps.
S1: ecological source vector data, land-use classification data, surface curvature data and population density data of an area to be researched are acquired.

The above various data acquired can be preprocessed as needed, respectively, and can be subjected to operations such as spatial registration.

In an example, the land-use pattern included in the land-use classification data includes eight categories in total, including a forest land, a shrub land, a high coverage grassland, a low coverage grassland, a cultivated land, a water body, an unused land and a construction land. The land-use patterns and their meanings are shown in the table below.

| Land-use pattern | Meaning |
|---|---|
| Forest land | The surface covered by natural forests, secondary forests and |
| | artificial forests |
| Shrub land | The vegetation primarily consisting of low-growing perennial |
| | shrub-type woody plants (where the shrub canopy coverage area |
| | accounts for more than 65%), in which a coverage is greater than |
| | 30%, and a height is generally less than 5 m |
| High coverage grassland | The natural grassland, the improved grassland and the mowed |
| | grassland with the coverage of greater than 50%, in which |
| | generally, the grassland has good water conditions and dense grass |
| | cover |
| Low coverage grassland | The natural grassland with the coverage of less than 50%, in which |
| | the grassland is short of water and has sparse grass cover and poor |
| | animal husbandry utilization conditions |
| Cultivated land | The land where crops are planted, including a mature cultivated |
| | land, a newly reclaimed wasteland, a fallow land, a shifting |
| | cultivated land, and a crop-grass rotation land; agricultural-fruit, |
| | agricultural-mulberry, and agricultural-forest lands primarily used |
| | for crop cultivation; a beach land and a mud flat cultivated for more |
| | than three years |
| Water body | The surface covered with liquid water and solid water |
| Unused land | The land that has not been used currently, including the land that is |
| | difficult to use |
| Construction land | The land used for industry, mining and transportation of urban and |
| | rural residential areas, as well as outside of counties and towns |

S2: a habitat suitability maximum similarity matrix of the area to be researched is established according to the land-use classification data.

Specifically, the implementation of this step includes:
establishing the following habitat suitability maximum similarity matrix of the area to be researched according to the land-use classification data;

| | | | High | Low | | | | |
|---|---|---|---|---|---|---|---|---|
| | Forest | Shrub | coverage | coverage | Cultivated | Water | Unused | Construction |
| | land | land | grassland | grassland | land | body | land | land |
| Forest | 1.0 | 0.9 | 0.7 | 0.6 | 0.4 | 0.3 | 0.1 | 0.0 |
| land | | | | | | | | |
| Shrub | 0.9 | 1.0 | 0.7 | 0.6 | 0.4 | 0.3 | 0.1 | 0.0 |
| land | | | | | | | | |
| High | 0.6 | 0.7 | 1.0 | 0.9 | 0.4 | 0.3 | 0.1 | 0.0 |
| coverage | | | | | | | | |
| grassland | | | | | | | | |
| Low | 0.6 | 0.7 | 0.9 | 1.0 | 0.4 | 0.3 | 0.1 | 0.0 |
| coverage | | | | | | | | |
| grassland | | | | | | | | |
| Cultivated | 0.4 | 0.6 | 0.7 | 0.9 | 1.0 | 0.3 | 0.1 | 0.0 |
| land | | | | | | | | |
| Water | 0.7 | 0.6 | 0.4 | 0.3 | 0.9 | 1.0 | 0.1 | 0.0 |
| body | | | | | | | | |

S3: an initial habitat suitability index is assigned to each of all pixels according to the land-use pattern of an ecological source and the habitat suitability maximum similarity matrix, to calculate basic resistance surface data of the area to be researched.

Specifically, the basic resistance surface data is as follows:

| | Basic resistance |
|---|---|
| Land-use pattern | surface data |
| Forest land | 5 |
| Shrub land | 10 |
| High coverage grassland | 20 |
| Low coverage grassland | 30 |
| Cultivated land | 50 |
| Water body | 100 |
| Unused land | 300 |
| Construction land | 500 |

S4: the initial habitat suitability index of each pixel is corrected according to the surface curvature data and the population density data, to obtain an ecological corridor suitability evaluation index of each pixel, and final resistance surface data of the area to be researched is calculated according to the ecological corridor suitability evaluation index.

As an example, this step includes the following steps.
S41: a correction coefficient of each pixel is calculated according to the surface curvature data and the population density data;

$${MC}_{i} = 1 - {IC}_{i} ,$$

$${IC}_{i} = \frac{{IS}_{i} - {IS}_{min}}{{IS}_{max} - {IS}_{min}} ,$$

$${IS}_{i} = \frac{{SC}_{i} - {SC}_{min}}{{SC}_{max} - {SC}_{min}} + \frac{{PD}_{i} - {PD}_{min}}{{PD}_{max} - {PD}_{min}} ,$$

where MCᵢ denotes a correction coefficient of an i-th pixel, where i=1, 2, . . . , N, N denotes the total number of pixels, ICᵢ denotes an interference coefficient of the i-th pixel, ISᵢ denotes an interference score of the i-th pixel, ISₘₐₓ and ISₘᵢₙ denote a maximum value and a minimum value of ISᵢ, respectively, SCᵢ denotes a surface curvature of the i-th pixel, SCₘₐₓ and SCₘᵢₙ denote a maximum value and a minimum value of SCᵢ, respectively, PDᵢ denotes a population density of the i-th pixel, and PDₘₐₓ and PDₘᵢₙ denote a maximum value and a minimum value of PDᵢ, respectively.
S42: the habitat suitability index of each pixel is corrected according to the correction coefficient, to obtain the ecological corridor suitability evaluation index of each pixel;

$${CS}_{i} = {HS}_{i} * {MC}_{i} ,$$

where HSᵢ denotes the habitat suitability index of the i-th pixel, and CSᵢ denotes the ecological corridor suitability evaluation index of the i-th pixel.
S43: the final resistance surface data of each pixel is calculated according to the ecological corridor suitability evaluation index;

$${R}_{i} = 1 - {CS}_{i} ,$$

where Rᵢ denotes the unsuitability evaluation index of the ecological corridor, that is, the final resistance surface data of the i-th pixel.
S5: for any two selected ecological sources, a minimum cost distance of all paths from one ecological source to the other ecological source is calculated according to the resistance surface data, and a path corresponding to the minimum cost distance is taken as an ecological corridor between the two selected ecological sources.

The principle of the minimum cost path is to identify and select the direction and the path of the minimum cost between the habitat source and the target habitat by establishing a cost distance equation. The specific implementation includes the following steps.
S51: for the two selected ecological sources, all paths from the one ecological source to the other ecological source are constructed.

For example, it is assumed that there are M paths between the two selected ecological sources a and b, where k=1, 2, . . . , M, in which k denotes the k-th path.
S52: a cost distance of each path is calculated, the minimum cost distance is found, and the path corresponding to the minimum cost distance is taken as the ecological corridor between the two selected ecological sources;

$$\begin{matrix}{lcd}_{a , b} = min ( {cd}_{k} ) , \\ {cd}_{k} = {\sum }_{j = 1}^{{N}_{k} - 1} {e}_{j , j + 1} , \\ {e}_{j , j + 1} = ( \frac{{c}_{j}}{2} + \frac{{c}_{j + 1}}{2} ) {d}_{j , j + 1} ,\end{matrix}$$

where lcd_{a,b} denotes the minimum cost distance between the two selected ecological sources a and b, cdₖ denotes the cost distance of a k-th path between the two selected ecological sources a and b, where k=1, 2, . . . , M, M denotes the total number of paths between the two selected ecological sources a and b; e_{j,j+1} denotes a cumulative cost of the j-th and (j+1)-th land-use pattern patches that the k-th path passes through, where j=1, 2, . . . , Nₖ−1, Nₖ denotes the total number of the land-use pattern patches that the k-th path passes through, cⱼ and cⱼ₊₁ denote average values of the resistance surface data of all pixels of the j-th and (j+1)-th land-use pattern patches, respectively, and d_{j,j+1} denotes a center distance between the j-th and (j+1)-th land-use pattern patches.

The present disclosure firstly determines the ecosystem type according to the determined ecological source, and assigns a habitat suitability index; and according to a maximum similarity matrix between different ecosystems, assigns the habitat suitability index to peripheral pixels of the selected ecological source, so as to obtain a similar value of the habitat suitability index. Then, the habitat suitability index is corrected according to the surface curvature data and population density data, and resistance surface data is calculated according to the corrected value. Finally, based on the resistance surface data, an ecological corridor is delineated comprehensively, so as to find one or more paths corresponding to a minimum cost distance as ecological corridors.

According to the present disclosure, the influence of the ecological environment on the establishment of the ecological corridor is taken into account more comprehensively, so that the ecological corridor can be applied into practice to the maximum extent. The establishment of the maximum similarity model is combined with the attributes of the pixels of the ecological source. For different ecosystems such as a forest land, a grassland and a wetland, the similarities vary with their different characteristics. The peripheral pixels of the ecological source are assigned according to the maximum similarity matrix, so that the differences between these ecosystems can be taken into account at the same time during the actual corridor delineation, thereby delineating the ecological corridor more accurately and providing a technical support for relevant departments to carry out ecological planning and biodiversity protection.

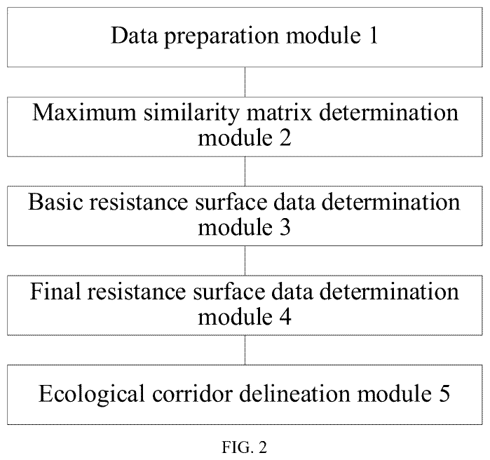

In an embodiment of the present disclosure, a device for delineating an ecological corridor based on a maximum similarity model is provided, as shown in FIG. 2. The device includes:
a data preparation module 1, configured to acquire ecological source vector data, land-use classification data, surface curvature data and population density data of an area to be researched;
a maximum similarity matrix determination module 2, configured to establish a habitat suitability maximum similarity matrix of the area to be researched according to the land-use classification data;
a basic resistance surface data determination module 3, configured to assign an initial habitat suitability index to each of all pixels according to the land-use pattern of an ecological source and the habitat suitability maximum similarity matrix, and calculate basic resistance surface data of the area to be researched;
a final resistance surface data determination module 4, configured to correct the initial habitat suitability index of each pixel according to the surface curvature data and the population density data, to obtain an ecological corridor suitability evaluation index of each pixel, and calculate final resistance surface data of the area to be researched according to the ecological corridor suitability evaluation index;
an ecological corridor delineation module 5, configured to, for any two selected ecological sources, calculate a minimum cost distance of all paths from one of the ecological sources to the other ecological source according to the final resistance surface data, and take a path corresponding to the minimum cost distance as an ecological corridor between the two selected ecological sources.

According to the present disclosure, the influence of the ecological environment on the establishment of the ecological corridor is taken into account more comprehensively, so that the ecological corridor can be applied into practice to the maximum extent. The establishment of the maximum similarity model is combined with the attributes of the pixels of the ecological source. For different ecosystems such as a forest land, a grassland and a wetland, the similarities vary with their different characteristics. The peripheral pixels of the ecological source are assigned according to the maximum similarity matrix, so that the differences between these ecosystems can be taken into account at the same time during the actual corridor delineation, thereby delineating the ecological corridor more accurately and providing a technical support for relevant departments to carry out ecological planning and biodiversity protection.

Specifically, the land-use pattern included in the land-use classification data includes a forest land, a shrub land, a high coverage grassland, a low coverage grassland, a cultivated land, a water body, an unused land and a construction land.

Correspondingly, the maximum similarity matrix determination module described above is configured to: establish the following habitat suitability maximum similarity matrix of the area to be researched according to the land-use classification data;

| | | | High | Low | | | | |
|---|---|---|---|---|---|---|---|---|
| | Forest | Shrub | coverage | coverage | Cultivated | Water | Unused | Construction |
| | land | land | grassland | grassland | land | body | land | land |
| Forest | 1.0 | 0.9 | 0.7 | 0.6 | 0.4 | 0.3 | 0.1 | 0.0 |
| land | | | | | | | | |
| Shrub | 0.9 | 1.0 | 0.7 | 0.6 | 0.4 | 0.3 | 0.1 | 0.0 |
| land | | | | | | | | |
| High | 0.6 | 0.7 | 1.0 | 0.9 | 0.4 | 0.3 | 0.1 | 0.0 |
| coverage | | | | | | | | |
| grassland | | | | | | | | |
| Low | 0.6 | 0.7 | 0.9 | 1.0 | 0.4 | 0.3 | 0.1 | 0.0 |
| coverage | | | | | | | | |
| grassland | | | | | | | | |
| Cultivated | 0.4 | 0.6 | 0.7 | 0.9 | 1.0 | 0.3 | 0.1 | 0.0 |
| land | | | | | | | | |
| Water | 0.7 | 0.6 | 0.4 | 0.3 | 0.9 | 1.0 | 0.1 | 0.0 |
| body | | | | | | | | |

As an example, the final resistance surface data determination module described above includes:
a correction coefficient calculation unit, configured to calculate a correction coefficient of each pixel according to the surface curvature data and the population density data;

$$\begin{matrix}{MC}_{i} = 1 - {IC}_{i} , \\ {IC}_{i} = \frac{{IS}_{i} - {IS}_{min}}{{IS}_{min} - {IS}_{min}} , \\ {IS}_{i} = \frac{{SC}_{i} - {SC}_{min}}{{SC}_{max} - {SC}_{min}} + \frac{{PD}_{i} - {PD}_{min}}{{PD}_{max} - {PD}_{min}} ,\end{matrix}$$

where MCᵢ denotes the correction coefficient of an i-th pixel, where i=1, 2, . . . , N, N denotes the total number of pixels, ICH denotes an interference coefficient of the i-th pixel, ISᵢ denotes an interference score of the i-th pixel, ISₘₐₓ and ISₘᵢₙ denote a maximum value and a minimum value of ISᵢ, respectively, SCᵢ denotes a surface curvature of the i-th pixel, SCₘₐₓ and SCₘᵢₙ denote a maximum value and a minimum value of SCᵢ, respectively, PDᵢ denotes a population density of the i-th pixel, and PDₘₐₓ and PDₘᵢₙ denote a maximum value and a minimum value of PDᵢ, respectively;
an evaluation index calculation unit, configured to correct the habitat suitability index of each pixel according to the correction coefficient, to obtain the ecological corridor suitability evaluation index of each pixel;

$${CS}_{i} = {HS}_{i} * {MC}_{i} ,$$

where HSᵢ denotes the habitat suitability index of the i-th pixel, and CSᵢ denotes the ecological corridor suitability evaluation index of the i-th pixel;
a resistance surface calculation unit, configured to calculate the final resistance surface data of each pixel according to the ecological corridor suitability evaluation index;

$${R}_{i} = 1 - {CS}_{i} ,$$

where Rᵢ denotes the final resistance surface data of the i-th pixel.

As an improvement of the embodiment of the present disclosure, the ecological corridor delineation module described above includes:
a path determination unit, configured to, for any two selected ecological sources, construct all paths from one of the ecological sources to the other ecological source;
an ecological corridor delineation unit, configured to calculate a cost distance of each path, find a minimum cost distance, and take the path corresponding to the minimum cost distance as the ecological corridor between the two selected ecological sources;

$$\begin{matrix}{lcd}_{a , b} = min ( {cd}_{k} ) , \\ {cd}_{k} = {\sum }_{j = 1}^{{N}_{k} - 1} {e}_{j , j + 1} , \\ {e}_{j , j + 1} = ( \frac{{c}_{j}}{2} + \frac{{c}_{j + 1}}{2} ) {d}_{j , j + 1} ,\end{matrix}$$

where lcd_{a,b} denotes the minimum cost distance between the two selected ecological sources a and b, cdₖ denotes the cost distance of a k-th path between the two selected ecological sources a and b, where k=1, 2, . . . , M, M denotes the total number of paths between the two selected ecological sources a and b; e_{j,j+1} denotes a cumulative cost of the j-th and (j+1)-th land-use pattern patches that the k-th path passes through, where j=1, 2, . . . , Nₖ−1, Nₖ denotes the total number of the land-use pattern patches that the k-th path passes through, cⱼ and cⱼ₊₁ denote average values of the resistance surface data of all pixels of the j-th and (j+1)-th land-use pattern patches, respectively, and d_{j,j+1} denotes a center distance between the j-th and (j+1)-th land-use pattern patches.

The device provided in the embodiment of the present disclosure has the same implementation principle and resulting technical effect as the above-mentioned method embodiment. For brief description, any aspects not mentioned in the device embodiment can refer to the corresponding contents of the above-mentioned method embodiment. It can be clearly understood by those skilled in the art that, for the convenience and conciseness of description, the specific working processes of the devices and units described above can all refer to the corresponding processes in the above-mentioned method embodiment, which will not be described in detail here.

It should be noted that according to the description of the related method embodiment the device or system described above in this specification can further include other embodiments, and the specific implementation can refer to the description of method embodiment, which will not be described in detail here. The various embodiments in this specification are described in a progressive manner. The same or similar parts between the various embodiments can be referred to each other. Each embodiment focuses on the differences from other embodiments. In particular, the hardware+program and storage medium+program embodiments are described relatively simply because of being basically similar to the method embodiment. The relevant parts can be referred to the partial description of the method embodiment.

Specific embodiments of this specification have been described hereinabove. Other embodiments are within the scope of the appended claims. In some cases, the actions or steps recited in the claims may be performed in a different order than in the embodiments and still achieve the desired results. In addition, the processes depicted in the drawings do not necessarily follow the particular order or sequential order required to be shown in order to achieve the desired results. In some embodiments, multitasking and parallel processing operations are also possible or may be advantageous.

The systems, devices, modules or units set forth in the above embodiments can be specifically implemented by computer chips or entities or by products with certain functions. A typical implementation device is a computer. Specifically, the computer can be, for example, a personal computer, a laptop computer, a vehicle-mounted human-computer interaction device, a cellular phone, a camera phone, a smart phone, a personal digital assistant, a media player, a navigation device, an email device, a game console, a tablet computer, a wearable device or any combination of these devices.

For the convenience of description, the above devices are described separately in terms of function into various modules. Apparently, it is possible to implement one or more embodiments of this specification in such a way that the functions of each module can be achieved in one or more software and/or hardware, and the module that achieves the same function can also be achieved by the combination of multiple sub-modules or sub-units, and so on. The device embodiments described above are merely schematic. For example, the division of the units is only a logical functional division. In actual implementation, there may be other division methods, for example, a plurality of units or components may be combined or integrated into another system, or some features may be ignored or not implemented. On the other hand, the mutual coupling or direct coupling or communication connection shown or discussed can be indirect coupling or communication connection through some interfaces, devices or units, and can be electrical, mechanical or in other forms.

It is also known for those skilled in the art that, in addition to implementing the controller in the form of a pure computer-readable program code, it is entirely possible to logically program the method steps to enable the controller to perform the same function in the form of logic gates, switches, application-specific integrated circuits, programmable logic controllers, embedded microcontrollers, etc. Therefore, such a controller can be regarded as a hardware component, and the devices included therein for achieving various functions can also be regarded as structures in the hardware component. Or even, the devices for achieving various functions can be regarded as both a software module for implementing the method and a structure within a hardware component.

The present disclosure is described with reference to flowcharts and/or block diagrams of methods, devices (systems) and computer program products according to the embodiments of the present disclosure. It should be understood that each flow and/or block in the flowchart and/or block diagram, and combinations of the flow and/or block in the flowchart and/or block diagram can be implemented by computer program instructions. These computer program instructions may be provided to a general-purpose computer, a special-purpose computer, an embedded processor or a processor of other programmable data processing devices to produce a machine, so that the instructions which are executed by the computer or the processor of the other programmable data processing devices produce means for implementing the functions specified in one or more flows in the flowchart and/or one or more blocks in the block diagram.

These computer program instructions may also be stored in a computer-readable memory that can direct a computer or other programmable data processing devices to function in a particular manner, so that the instructions stored in the computer-readable memory produce an article of manufacture including instruction means, and the instruction means implement the functions specified in one or more flows in the flowchart and/or one or more blocks in the block diagram.

These computer program instructions may also be loaded onto a computer or other programmable data processing devices, so that a series of operating steps are performed on the computer or other programmable devices to produce a computer-implemented process, such that the instructions executed on the computer or other programmable devices provide steps for implementing the functions specified in one or more flows in the flowchart and/or one or more blocks in the block diagram.

In a typical configuration, a computing device includes one or more central processing units (CPUs), an input/output (I/O) interface, a network interface, and a memory.

It should also be noted that the terms “including”, “comprising” or any other variation thereof are intended to cover non-exclusive inclusion, so that a process, a method, a product or a device including a series of elements includes not only those elements, but also other elements not explicitly listed, or elements inherent to such process, method, product or device. Without more restrictions, an element defined by the phrase “including one . . . ” does not exclude the existence of other identical elements in the process, method or device including the said element.

It should be understood by those skilled in the art that one or more embodiments of this specification may be provided as a method, a system or a computer program product. Accordingly, one or more embodiments of this specification may take the form of an entirely hardware embodiment, an entirely software embodiment or an embodiment combining software and hardware aspect. Furthermore, one or more embodiments of this specification may take the form of a computer program product implemented on one or more computer-usable storage media (including but not limited to a disk storage, a CD-ROM, an optical storage, etc.) in which computer-usable program codes are included.

One or more embodiments of this specification may be described in the general context of a computer-executable instruction executed by a computer, such as a program module. Generally, the program module includes a routine, a program, an object, a component, a data structure, etc., which perform particular tasks or implement particular abstract data types. One or more embodiments of this specification may also be practiced in a distributed computing environment where tasks are perform by a remote processing device that are connected through a communication network. In the distributed computing environment, the program module may be located in the local and remote computer storage media including storage devices.

The various embodiments in this specification are described in a progressive manner. The same or similar parts between the various embodiments can be referred to each other. Each embodiment focuses on the differences from other embodiments. Especially, the system embodiment is described relatively simply because of being basically similar to the method embodiment, and the relevant parts can be referred to the partial description of the method embodiment. In the description of this specification, descriptions about the reference terms “one embodiment”, “some embodiments”, “example”, “specific examples” or “some examples” mean that specific features, structures, materials or characteristics described in conjunction with this embodiment or example are included in at least one embodiment or example of this specification. In this specification, the schematic expressions of the above terms are not necessarily aimed at the same embodiment or example. Moreover, the specific features, structures, materials or characteristics described may be combined in any one or more embodiments or examples in a suitable manner. In addition, those skilled in the art can combine and integrate different embodiments or examples and features of different embodiments or examples described in this specification without contradicting each other.

Finally, it should be explained that the above-mentioned embodiments are only specific implementation of the present disclosure, which is used to illustrate the technical scheme of the present disclosure, rather than limit the technical scheme. The protection scope of the present disclosure is not limited thereto. Although the present disclosure has been described in detail with reference to the above-mentioned embodiments, it should be understood by those skilled in the art that any person familiar with the technical field can still modify the technical scheme described in the above-mentioned embodiments or easily conceive of changes to the technical scheme within the technical scope disclosed by the present disclosure, or make equivalent substitutions to some of the technical features. However, these modifications, changes or substitutions do not make the essence of the corresponding technical scheme deviate from the spirit and the scope of the technical scheme of the embodiment of the present disclosure, all of which should be covered within the protection scope of the present disclosure. Therefore, the protection scope of the present disclosure should be based on the protection scope of the claims.

What is claimed is:

1. A method for delineating an ecological corridor based on a maximum similarity model, comprising:
S1: acquiring ecological source vector data, land-use classification data, surface curvature data, and population density data of an area to be researched;
S2: establishing a habitat suitability maximum similarity matrix of the area to be researched according to the land-use classification data;
S3: assigning an initial habitat suitability index to each of all pixels according to a land-use pattern of an ecological source and the habitat suitability maximum similarity matrix, to calculate basic resistance surface data of the area to be researched;
S4: correcting the initial habitat suitability index of each pixel according to the surface curvature data and the population density data, to obtain an ecological corridor suitability evaluation index of each pixel, and calculating final resistance surface data of the area to be researched according to the ecological corridor suitability evaluation index; and
S5: for two selected ecological sources, calculating a minimum cost distance of all paths from a first ecological source to a second ecological source according to the final resistance surface data, and taking a path corresponding to the minimum cost distance as an ecological corridor between the two selected ecological sources.

2. The method for delineating the ecological corridor based on the maximum similarity model according to claim 1, wherein the land-use pattern comprised in the land-use classification data comprises a forest land, a shrub land, a high coverage grassland, a low coverage grassland, a cultivated land, a water body, an unused land, and a construction land.

3. The method for delineating the ecological corridor based on the maximum similarity model according to claim 2, wherein the S2 comprises:
establishing the following habitat suitability maximum similarity matrix of the area to be researched according to the land-use classification data;

| | | | high | low | | | | |
|---|---|---|---|---|---|---|---|---|
| | forest | shrub | coverage | coverage | cultivated | water | unused | construction |
| | land | land | grassland | grassland | land | body | land | land |
| forest | 1.0 | 0.9 | 0.7 | 0.6 | 0.4 | 0.3 | 0.1 | 0.0 |
| land | | | | | | | | |
| shrub | 0.9 | 1.0 | 0.7 | 0.6 | 0.4 | 0.3 | 0.1 | 0.0 |
| land | | | | | | | | |
| high | 0.6 | 0.7 | 1.0 | 0.9 | 0.4 | 0.3 | 0.1 | 0.0 |
| coverage | | | | | | | | |
| grassland | | | | | | | | |
| low | 0.6 | 0.7 | 0.9 | 1.0 | 0.4 | 0.3 | 0.1 | 0.0 |
| coverage | | | | | | | | |
| grassland | | | | | | | | |
| cultivated | 0.4 | 0.6 | 0.7 | 0.9 | 1.0 | 0.3 | 0.1 | 0.0 |
| land | | | | | | | | |
| water | 0.7 | 0.6 | 0.4 | 0.3 | 0.9 | 1.0 | 0.1 | 0.0 |
| body | | | | | | | | |

4. The method for delineating the ecological corridor based on the maximum similarity model according to claim 3, wherein the S4 comprises:
S41: calculating a correction coefficient of each pixel according to the surface curvature data and the population density data;
$$\begin{matrix}{MC}_{i} = 1 - {IC}_{i} \\ {IC}_{i} = \frac{{IS}_{i} - {IS}_{min}}{{IS}_{max} - {IS}_{min}} \\ {IS}_{i} = \frac{{SC}_{i} - {SC}_{min}}{{SC}_{max} - {SC}_{min}} + \frac{{PD}_{i} - {PD}_{min}}{{PD}_{max} - {PD}_{min}}\end{matrix}$$
wherein MCᵢ denotes the correction coefficient of an i-th pixel, wherein i=1, 2, . . . , N, N denotes a total number of the pixels, ICH denotes an interference coefficient of the i-th pixel, ISᵢ denotes an interference score of the i-th pixel, ISₘₐₓ and ISₘᵢₙ denote a maximum value and a minimum value of ISᵢ, respectively, SCᵢ denotes a surface curvature of the i-th pixel, SCₘₐₓ and SCₘᵢₙ denote a maximum value and a minimum value of SCᵢ, respectively, PDᵢ denotes a population density of the i-th pixel, and PDₘₐₓ and PDₘᵢₙ denote a maximum value and a minimum value of PDᵢ, respectively;
S42: correcting the initial habitat suitability index of each pixel according to the correction coefficient of each pixel, to obtain the ecological corridor suitability evaluation index of each pixel;
$${CS}_{i} = {HS}_{i} * {MC}_{i}$$
wherein HSᵢ denotes the initial habitat suitability index of the i-th pixel, and CSᵢ denotes the ecological corridor suitability evaluation index of the i-th pixel;
S43: calculating final resistance surface data of each pixel according to the ecological corridor suitability evaluation index of each pixel;
$${R}_{i} = 1 - {CS}_{i}$$
wherein Rᵢ denotes the final resistance surface data of the i-th pixel.

5. The method for delineating the ecological corridor based on the maximum similarity model according to claim 4, wherein the S5 comprises:
S51: for the two selected ecological sources, constructing all paths from the first ecological source to the second ecological source;
S52: calculating a cost distance of each path, finding the minimum cost distance, and taking the path corresponding to the minimum cost distance as the ecological corridor between the two selected ecological sources;
$$\begin{matrix}{lcd}_{a , b} = min ( {cd}_{k} ) , \\ {cd}_{k} = {\sum }_{j = 1}^{{N}_{k} - 1} {e}_{j , j + 1} , \\ {e}_{j , j + 1} = ( \frac{{c}_{j}}{2} + \frac{{c}_{j + 1}}{2} ) {d}_{j , j + 1} ,\end{matrix}$$
wherein lcd_{a,b} denotes the minimum cost distance between the two selected ecological sources a and b, cdₖ denotes the cost distance of a k-th path between the two selected ecological sources a and b, wherein k=1, 2, . . . , M, M denotes a total number of the paths between the two selected ecological sources a and b; e_{j,j+1} denotes a cumulative cost of j-th and (j+1)-th land-use pattern patches that the k-th path passes through, wherein j=1, 2, . . . , Nₖ−1, Nₖ denotes a total number of land-use pattern patches that the k-th path passes through, cⱼ and cⱼ₊₁ denote average values of resistance surface data of all pixels of the j-th and (j+1)-th land-use pattern patches, respectively, and d_{j,j+1} denotes a center distance between the j-th and (j+1)-th land-use pattern patches.

6. A device for delineating an ecological corridor based on a maximum similarity model, comprising:
a data preparation module, configured to acquire ecological source vector data, land-use classification data, surface curvature data, and population density data of an area to be researched;
a maximum similarity matrix determination module, configured to establish a habitat suitability maximum similarity matrix of the area to be researched according to the land-use classification data;
a basic resistance surface data determination module, configured to assign an initial habitat suitability index to each of all pixels according to a land-use pattern of an ecological source and the habitat suitability maximum similarity matrix, and calculate basic resistance surface data of the area to be researched;
a final resistance surface data determination module, configured to correct the initial habitat suitability index of each pixel according to the surface curvature data and the population density data, to obtain an ecological corridor suitability evaluation index of each pixel, and calculate final resistance surface data of the area to be researched according to the ecological corridor suitability evaluation index; and
an ecological corridor delineation module, configured to, for two selected ecological sources, calculate a minimum cost distance of all paths from a first ecological source to a second ecological source according to the final resistance surface data, and take a path corresponding to the minimum cost distance as an ecological corridor between the two selected ecological sources.

7. The device for delineating the ecological corridor based on the maximum similarity model according to claim 6, wherein the land-use pattern comprised in the land-use classification data comprises a forest land, a shrub land, a high coverage grassland, a low coverage grassland, a cultivated land, a water body, an unused land, and a construction land.

8. The device for delineating the ecological corridor based on the maximum similarity model according to claim 7, wherein the maximum similarity matrix determination module is configured to: establish the following habitat suitability maximum similarity matrix of the area to be researched according to the land-use classification data;

| | | | high | low | | | | |
|---|---|---|---|---|---|---|---|---|
| | forest | shrub | coverage | coverage | cultivated | water | unused | construction |
| | land | land | grassland | grassland | land | body | land | land |
| forest | 1.0 | 0.9 | 0.7 | 0.6 | 0.4 | 0.3 | 0.1 | 0.0 |
| land | | | | | | | | |
| shrub | 0.9 | 1.0 | 0.7 | 0.6 | 0.4 | 0.3 | 0.1 | 0.0 |
| land | | | | | | | | |
| high | 0.6 | 0.7 | 1.0 | 0.9 | 0.4 | 0.3 | 0.1 | 0.0 |
| coverage | | | | | | | | |
| grassland | | | | | | | | |
| low | 0.6 | 0.7 | 0.9 | 1.0 | 0.4 | 0.3 | 0.1 | 0.0 |
| coverage | | | | | | | | |
| grassland | | | | | | | | |
| cultivated | 0.4 | 0.6 | 0.7 | 0.9 | 1.0 | 0.3 | 0.1 | 0.0 |
| land | | | | | | | | |
| water | 0.7 | 0.6 | 0.4 | 0.3 | 0.9 | 1.0 | 0.1 | 0.0 |
| body | | | | | | | | |

9. The device for delineating the ecological corridor based on the maximum similarity model according to claim 8, wherein the final resistance surface data determination module comprises:
a correction coefficient calculation unit, configured to calculate a correction coefficient of each pixel according to the surface curvature data and the population density data;
$$\begin{matrix}{MC}_{i} = 1 - {IC}_{i} \\ {IC}_{i} = \frac{{IS}_{i} - {IS}_{min}}{{IS}_{max} - {IS}_{min}} \\ {IS}_{i} = \frac{{SC}_{i} - {SC}_{min}}{{SC}_{max} - {SC}_{min}} + \frac{{PD}_{i} - {PD}_{min}}{{PD}_{max} - {PD}_{min}}\end{matrix}$$
wherein MCᵢ denotes the correction coefficient of an i-th pixel, wherein i=1, 2, . . . , N, N denotes a total number of the pixels, ICᵢ denotes an interference coefficient of the i-th pixel, ISᵢ denotes an interference score of the i-th pixel, ISₘₐₓ and ISₘᵢₙ denote a maximum value and a minimum value of ISᵢ, respectively, SCᵢ denotes a surface curvature of the i-th pixel, SCₘₐₓ and SCₘᵢₙ denote a maximum value and a minimum value of SCᵢ, respectively, PDᵢ denotes a population density of the i-th pixel, and PDₘₐₓ and PDₘᵢₙ denote a maximum value and a minimum value of PDᵢ, respectively;
an evaluation index calculation unit, configured to correct the initial habitat suitability index of each pixel according to the correction coefficient of each pixel, to obtain the ecological corridor suitability evaluation index of each pixel;
$${CS}_{i} = {HS}_{i} * {MC}_{i} ,$$
wherein HSᵢ denotes the initial habitat suitability index of the i-th pixel, and CSᵢ denotes the ecological corridor suitability evaluation index of the i-th pixel;
a resistance surface calculation unit, configured to calculate final resistance surface data of each pixel according to the ecological corridor suitability evaluation index of each pixel;
$${R}_{i} = 1 - {CS}_{i}$$
wherein Rᵢ denotes the final resistance surface data of the i-th pixel.

10. The device for delineating the ecological corridor based on the maximum similarity model according to claim 9, wherein the ecological corridor delineation module comprises:
a path determination unit, configured to, for the two selected ecological sources, construct all paths from the first ecological source to the second ecological source;
an ecological corridor delineation unit, configured to calculate a cost distance of each path, find the minimum cost distance, and take the path corresponding to the minimum cost distance as the ecological corridor between the two selected ecological sources;
$$\begin{matrix}{lcd}_{a , b} = min ( {cd}_{k} ) , \\ {cd}_{k} = {\sum }_{j = 1}^{{N}_{k} - 1} {e}_{j , j + 1} , \\ {e}_{j , j + 1} = ( \frac{{c}_{j}}{2} + \frac{{c}_{j + 1}}{2} ) {d}_{j , j + 1} ,\end{matrix}$$
wherein lcd_{a,b} denotes the minimum cost distance between the two selected ecological sources a and b, cdₖ denotes the cost distance of a k-th path between the two selected ecological sources a and b, wherein k=1, 2, . . . , M, M denotes a total number of the paths between the two selected ecological sources a and b; e_{j,j+1} denotes a cumulative cost of j-th and (j+1)-th land-use pattern patches that the k-th path passes through, wherein j=1, 2, . . . , Nₖ−1, NR denotes a total number of land-use pattern patches that the k-th path passes through, cⱼ and cⱼ₊₁ denote average values of resistance surface data of all pixels of the j-th and (j+1)-th land-use pattern patches, respectively, and d_{j,j+1} denotes a center distance between the j-th and (j+1)-th land-use pattern patches.
